(19) United States
(12) Patent Application Publication
(10) Pub. No.: US 2017/0168219 A1
(43) Pub. Date: Jun. 15, 2017

(54) BACKLIGHT MODULE, DISPLAY MODULE, AND DISPLAY DEVICE

(71) Applicants: Le Holdings(Beijing)Co., Ltd., Beijing (CN); LE SHI ZHI XIN ELECTRONIC TECHNOLOGY (TIAN JIN) LIMITED, Tianjin (CN)

(72) Inventor: Changjia FU, Tianjin (CN)

(21) Appl. No.: 15/246,179

(22) Filed: Aug. 24, 2016

Related U.S. Application Data
(63) Continuation of application No. PCT/CN2016/088968, filed on Jul. 6, 2016.

(30) Foreign Application Priority Data
Dec. 10, 2015 (CN) 201521036559.6

(51) Int. Cl. F21V 8/00

(52) U.S. Cl. CPC G02B 6/0033; G02B 6/0068

(57) ABSTRACT

Disclosed are a backlight module, a display module, and a display device. The backlight module includes: a back cover including an accommodating space; and a light guide plate, LED bars, and a laser device arranged in the accommodating space of the back cover, wherein the LED bars are located at the light incidence side of the light guide plate, the laser device is located on a non-light incidence side of the light guide plate adjacent to the light incidence side, and emits laser passing through an edge of the light guide plate at the light incidence side, wherein the color of the laser emitted by the laser device matches the color of light rays emitted by LEDs in the LED bars. In the technical solution according to the embodiments of the application, the laser device is arranged at the non-light incidence side of the light guide plate adjacent to the light incidence side, and emits the laser passing through the edge of the light guide plate at the light incidence side; and with this design, the brightness at the light incidence side of the backlight module illuminated by the laser can tend to become uniform to thereby weaken the phenomenon of lamp shadow in the backlight module, and further improve the quality of a picture on the display device.

### CROSS REFERENCE TO RELATED APPLICATIONS

This application is a continuation of International Application No. PCT/CN2016/088968, filed on Jul. 6, 2016, which is based upon and claims priority to Chinese Patent Application No. 201521036559.6, filed on Dec. 10, 2015, the entire contents of which are incorporated herein by reference.

### TECHNICAL FIELD

The disclosure relates to the field of display technologies, and particularly to a backlight module, a display module, and a display device.

### BACKGROUND

At present, Light Emitting Diodes (LEDs) are commonly used as light sources in a backlight module of a liquid crystal display device. The backlight module can be categorized into a backlight module of side light type and a backlight module of straight down type, dependent upon the positions where the light sources are distributed, where strips of LED lamps in the backlight module of side light type are located at side ends of a light guide plate, and such a backlight module is generally applicable to a notebook PC, a palm PC, a handset, or another display device with a small size. As the LED related technologies are developing constantly, the backlight module of side light type is also coming to be applicable to a display device with a large size to thereby bring a better visual experience of a user.

The structure of the backlight module of side light type generally includes: a back cover including an accommodating space; a reflector plate, a light guide plate, and an optical film sheet arranged in order in the accommodating space of the back cover; and LED bars located in the accommodating space of the back cover at the light incidence side of the light guide plate; and a glue frame located above the optical film sheet and connected with the back cover, where the back cover 10, the light guide plate 11, and the LED bars 12 are structured as illustrated in FIG. 1.

In the prior art, since LEDs in the LED bars 12 emit light at a limited angle, as illustrated in FIG. 1, there are such strong light rays in the area facing each LED that a bright strip A1 at high brightness is formed in the area facing the LED, and a dark strip A2 at low brightness is formed in the area facing the gap between two adjacent LEDs, thus resulting in the phenomenon of alternating bright and dark strips, which is referred to as lamp shadow. The quality of a picture displayed on the display device may be degraded due to the lamp shadow.

### SUMMARY

Embodiments of the application provide a backlight module, a display module, and a display device so as to weaken the phenomenon of lamp shadow in the backlight module, and further improve the quality of a picture on the display device.

An embodiment of the application provides a backlight module including: a back cover including an accommodating space; and a light guide plate, LED bars, and a laser device arranged in the accommodating space of the back cover, wherein LED bars are located at the light incidence side of the light guide plate, the laser device is located on a non-light incidence side of the light guide plate adjacent to the light incidence side, and emits laser passing through an edge of the light guide plate at the light incidence side, wherein the color of the laser emitted by the laser device matches the color of light rays emitted by LEDs in LED bars.

An embodiment of the application provides a display module including the backlight module according to any one of the technical solutions above. There are such uniform light rays at the light incidence side of the backlight module of the display module that the quality of a picture at the light incidence side is high, so there is a good effect of displaying the picture on the display module.

An embodiment of the application provides a display device including the display module according to the technical solution above. The display device has a high quality of a picture, and a good effect of displaying the picture.

Optionally the display device includes a liquid crystal TV set, a liquid crystal display, or a display screen of a handset.

### BRIEF DESCRIPTION OF THE DRAWINGS

In order to make the technical solutions according to the embodiments of the application or in the prior art more apparent, the drawings to which a description of the embodiments or the prior art refers will be briefly introduced below, and apparently the drawings to be described below are merely illustrative of some of the embodiments of the application, and those ordinarily skilled in the art can derive from these drawings without any inventive effort.

One or more embodiments are illustrated by way of example, and not by limitation, in the figures of the accompanying drawings, wherein elements having the same reference numeral designations represent like elements throughout. The drawings are not to scale, unless otherwise disclosed. In the drawings:

FIG. 1 is a schematic structural diagram of the backlight module in the prior art; and

FIG. 2 is a schematic structural diagram of a backlight module according to some embodiments of the application.

### REFERENCE NUMERALS

10—Back cover
11—Light guide plate
12—LED bar
130—Light rays emitted by LEDs
A1—Bright strip
A2—Dark strip
20—Laser device
21—Laser

### DETAILED DESCRIPTION

In order to make the objects, technical solutions, and advantages of the embodiments of the application more apparent, the technical solutions according to the embodiments of the application will be described below clearly and fully with reference to the drawings in the embodiments of the application, and apparently the embodiments described below are only a part but not all of the embodiments of the application. Based upon the embodiments here of the application, all the other embodiments which can occur to those skilled in the art without any inventive effort shall fall into the scope of the application.

As illustrated in FIG. 2, a backlight module according to an embodiment of the application includes: a back cover 10 including an accommodating space; and a light guide plate 11, LED bars 12, and a laser device 20 arranged in the accommodating space of the back cover 10, where the LED bars 12 are located at the light incidence side of the light guide plate 11, the laser device 20 is located on a non-light incidence side of the light guide plate adjacent to the light incidence side, and emits laser 21 passing through an edge of the light guide plate 11 at the light incidence side, where the color of the laser 21 emitted by the laser device matches the color of light rays 13 emitted by LEDs in the LED bars.

In the embodiment of the application, the laser device is arranged at the non-light incidence side of the light guide plate adjacent to the light incidence side, and emits the laser passing through the edge of the light guide plate at the light incidence side; and with this design, the brightness at the light incidence side of the backlight module illuminated by the laser can tend to become uniform to thereby weaken the phenomenon of lamp shadow in the backlight module, and further improve the quality of a picture on a display device.

In an embodiment of the application, the backlight module further includes a reflector plate and an optical film sheet arranged in the accommodating space of the back cover, where the light guide plate is arranged above the reflecting sheet, and the optical film sheet is arranged above the light guide plate.

Here the light rays emitted by the LEDs in the LED bars will not be limited to any particular color, and the color of the laser emitted by the laser device will not be limited to any particular color either; and it shall be noted that the color of the laser emitted by the laser device shall match with the color of the laser emitted by the LEDs.

Particularly the LEDs can be white LEDs, and the laser device can be a white laser device. The laser device can emit more uniform white color so that the light rays at the light incidence side will become uniform.

More preferably the laser device is a brightness-adjustable laser device. If the laser device is a brightness-adjustable laser device, the brightness of the laser emitted by the laser device can be adjusted for optimum uniformity of the brightness at the edge of the light incidence side so as to improve the quality of a picture in the backlight module. Moreover the laser device will not be limited to any particular fixed position, for example, the laser device can be fixed on a sidewall of the back cover, the bottom wall of the back cover, etc.; and the laser device can be fixed in the back cover in any appropriate manner, for example, the laser device can be fixed in the back cover using a double-sided adhesive tape.

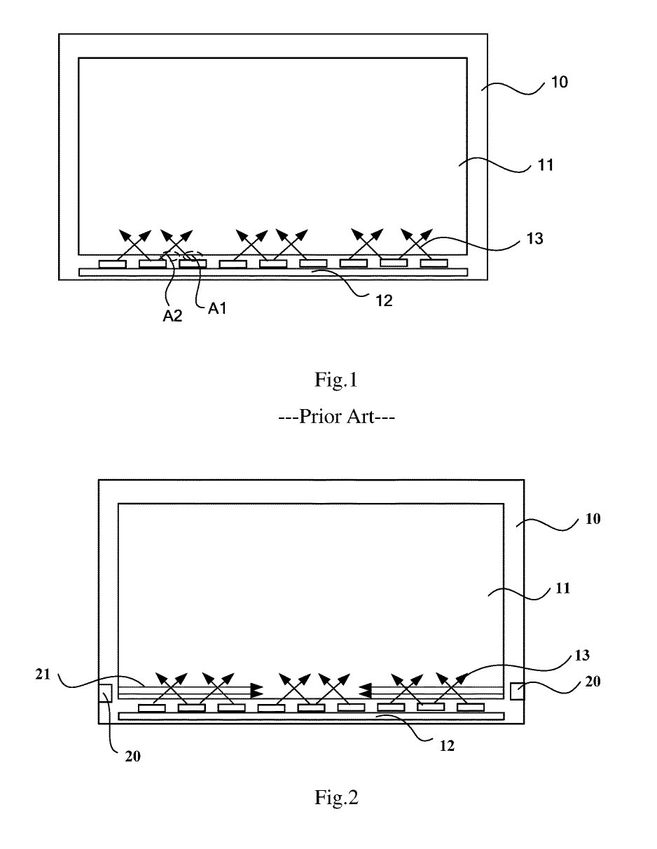

In a preferred embodiment of the application, as illustrated in FIG. 1, there are two lasers 20 in the backlight module, which are located respectively at two non-light incidence sides of the light guide plate adjacent to the light incidence side, and which emit opposite laser 21.

In this preferred embodiment, the lasers are arranged on both of the non-light incidence sides of the light guide plate adjacent to the light incidence side, and emit the opposite laser, so that the light rays at the light incidence side of the backlight module can become more uniform, thus resulting in a higher quality of a picture in the backlight module, and a better effect of displaying the picture on the display device.

An embodiment of the application provides a display module including the backlight module according to any one of the technical solutions above. There are uniform light rays at the light incidence side of the backlight module of the display module, thus resulting in a higher quality of a picture in the backlight module, and a better effect of displaying the picture on the display device.

An embodiment of the application provides a display device including the display module according to the technical solution above. The display device has a high quality of a picture, and a good effect of displaying the picture.

Optionally the display device includes a liquid crystal TV set, a liquid crystal display, or a display screen of a handset.

Lastly it shall be noted that the respective embodiments above are merely intended to illustrate but not to limit the technical solution of the application; and although the application has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the application as claimed.

What is claimed is:

1. A backlight module, comprising: a back cover comprising an accommodating space; and a light guide plate, LED bars, and a laser device arranged in the accommodating space of the back cover, wherein the LED bars are located at the light incidence side of the light guide plate, the laser device is located on a non-light incidence side of the light guide plate adjacent to the light incidence side, and emits laser passing through an edge of the light guide plate at the light incidence side, wherein the color of the laser emitted by the laser device matches the color of light rays emitted by LEDs in the LED bars.

2. The backlight module according to claim 1, wherein there are two lasers are located respectively at two non-light incidence sides of the light guide plate adjacent to the light incidence side, and which emit opposite laser.

3. The backlight module according to claim 1, wherein the laser device is fixed on a sidewall or a bottom wall of the back cover using a double-sided adhesive tape.

4. The backlight module according to claim 1, wherein LEDs in the LED bars are white LEDs, and the laser is a white laser.

5. The backlight module according to claim 4, wherein the laser is a brightness-adjustable laser.

6. A display module, comprising a liquid crystal panel and a backlight module; wherein the backlight module comprising:
a back cover comprising an accommodating space; and a light guide plate, LED bars, and a laser device arranged in the accommodating space of the back cover, wherein the LED bars are located at the light incidence side of the light guide plate, the laser device is located on a non-light incidence side of the light guide plate adjacent to the light incidence side, and emits laser passing through an edge of the light guide plate at the light incidence side, wherein the color of the laser emitted by the laser device matches the color of light rays emitted by LEDs in the LED bars.

7. The display module according to claim 6, wherein there are two lasers are located respectively at two non-light incidence sides of the light guide plate adjacent to the light incidence side, and which emit opposite laser.

8. The display module according to claim 6, wherein the laser device is fixed on a sidewall or a bottom wall of the back cover using a double-sided adhesive tape.

9. The display module according to claim 6, wherein LEDs in the LED bars are white LEDs, and the laser is a white laser.

10. The display module according to claim 9, wherein the laser is a brightness-adjustable laser.

11. A display device, comprising a display module, wherein the display module comprises a liquid crystal panel and a backlight module; wherein the backlight module comprising:
a back cover comprising an accommodating space; and a light guide plate, LED bars, and a laser device arranged in the accommodating space of the back cover, wherein the LED bars are located at the light incidence side of the light guide plate, the laser device is located on a non-light incidence side of the light guide plate adjacent to the light incidence side, and emits laser passing through an edge of the light guide plate at the light incidence side, wherein the color of the laser emitted by the laser device matches the color of light rays emitted by LEDs in the LED bars.

12. The display device according to claim 11, wherein the display device comprises a liquid crystal TV set, a liquid crystal display, or a display screen of a handset.

13. The display device according to claim 11, wherein there are two lasers are located respectively at two non-light incidence sides of the light guide plate adjacent to the light incidence side, and which emit opposite laser.

14. The display device according to claim 11, wherein the laser device is fixed on a sidewall or a bottom wall of the back cover using a double-sided adhesive tape.

15. The display device according to claim 11, wherein LEDs in the LED bars are white LEDs, and the laser is a white laser.

16. The display device according to claim 15, wherein the laser is a brightness-adjustable laser.
